(19) United States
(12) Patent Application Publication
(10) Pub. No.: US 2011/0263158 A1
(43) Pub. Date: Oct. 27, 2011

(54) ELECTRICAL CONNECTOR

(75) Inventors: Masayuki Nishikata, Tokyo (JP); Takashi Ehara, Tokyo (JP)

(73) Assignee: Japan Aviation Electronics Industry, Limited, Tokyo (JP)

(21) Appl. No.: 13/138,010

(22) PCT Filed: Aug. 7, 2009
(86) PCT No.: PCT/JP2009/063993

§ 371 Date: Jun. 23, 2011

(30) Foreign Application Priority Data
Mar. 9, 2009 (JP) 2009-055240

(51) Int. Cl. H01R 24/00

(52) U.S. Cl. 439/626

(57) ABSTRACT

An insulating housing of an electrical connector is separated into two parts of a mold-in portion (3) and a cover portion (4) covering the mold-in portion. In the mold-in portion, plural contacts (5) are held in parallel with one another by mold-in and an air layer (32) is formed to pass through between the contacts.

### TECHNICAL FIELD

This invention relates to an electrical connector in which plural contacts are mounted in parallel with one another in a housing.

### BACKGROUND ART

With the miniaturization of an electrical device or an electronic device in recent years, a connector used in these devices is also required to be miniaturized. Therefore, the connector is increasingly reduced in profile and the pitch of contacts or terminals arranged inside the connector in parallel with one another is increasingly narrowed. On the other hand, there is an increasing demand for the connector to perform high-speed transmission. However, as the pitch of the terminals is increasingly narrowed, adjacent ones of the terminals serve as a capacitor. As a result, due to occurrence of crosstalk and impedance mismatching, the high-speed transmission may become impossible.

For example, Patent Document 1 discloses an electrical connector in which a plurality of terminals press-fitted and held in a housing are provided with holes and in which spaces are formed between the terminals. According to the electrical connector, opposing areas between the terminals are decreased by the holes and air layers having a low dielectric constant are formed between the terminals by the spaces. As a result, capacitance components between the terminals are decreased. Therefore, reduction of crosstalk and impedance matching are easily achieved.

Prior Art Document:

Patent Document:

Patent Document 1: JP-A-2007-172940

### SUMMARY OF THE INVENTION

### Problem to be Solved by the Invention

However, in Patent Document 1, the terminals are held in the housing by a press-fit structure. Therefore, in order to obtain a necessary holding force, a press-fit portion of each terminal must be increased in width. As a result, the opposing area between the press-fit portions of the terminals is increased. Accordingly, it is difficult to expect further improvement regarding crosstalk and impedance.

Further, since the width of the press-fit portion of each terminal is increased, the electrical connector is increased in dimension in a vertical direction. Therefore, it is difficult to achieve reduction in profile of the electrical connector.

It is therefore an object of the present invention to provide an electrical connector which is advantageous in reduction of crosstalk and in impedance matching and which is easily reduced in profile.

### Means to Solve the Problem

According to an aspect of the present invention, there is provided an electrical connector comprising an insulating housing and a plurality of conductive contacts mounted to the housing, characterized in that each of the contacts extends in a first direction, the housing including a mold-in portion holding the contacts in parallel with one another by mold-in and a cover portion formed as an element separate from the mold-in portion and covering the mold-in portion, the mold-in portion being provided with an air layer which passes through between the contacts.

### Effect of the Invention

The connector according to one aspect of the present invention is advantageous in reduction of crosstalk and in impedance matching and is easily reduced in profile thereof.

### BRIEF DESCRIPTION OF THE DRAWING

FIG. 1 is an external perspective view of an electrical connector according to one embodiment of the present invention.

FIG. 2 is an exploded perspective view of the electrical connector in FIG. 1.

FIG. 3 is a perspective view of a molded component included in the electrical connector in FIG. 1.

FIG. 4 is a sectional perspective view taken along a line IV-IV in FIG. 1.

FIG. 5 is a sectional view taken along a line V-V in FIG. 1.

FIG. 6 shows views for describing a manufacturing method of the molded component in FIG. 3.

FIG. 7 is an external perspective view showing one example of a relay connector manufactured using the electrical connector in FIG. 1.

FIG. 8 is an exploded perspective view of the relay connector in FIG. 7.

FIG. 9 shows views for describing a manufacturing method of the relay connector in FIG. 7.

### MODE FOR EMBODYING THE INVENTION

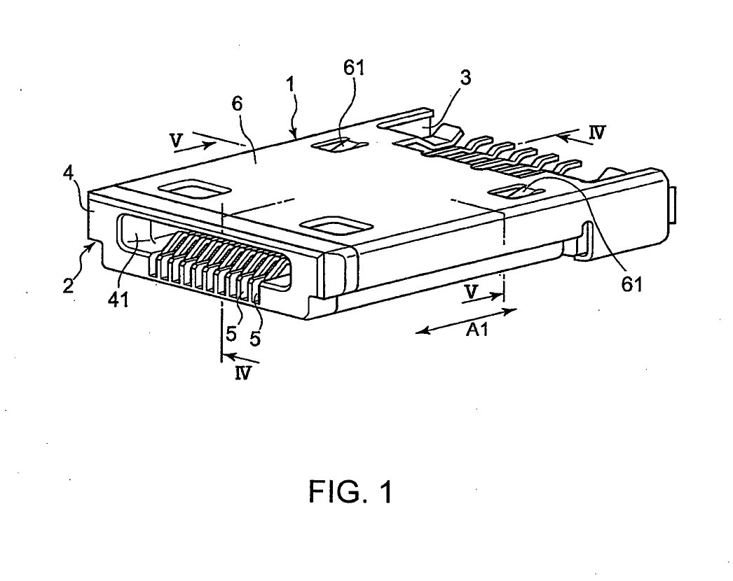

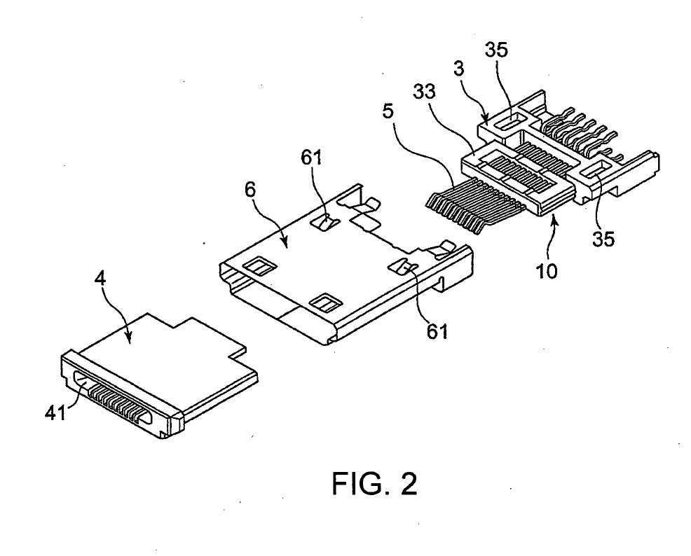

Referring to FIGS. 1 and 2, a whole structure of an electrical connector according to one embodiment of the present invention will be described.

The electrical connector 1 shown in the figure includes an insulating housing 2 and a plurality of conductive contacts 5 mounted in the housing 2. The housing 2 includes a resin mold-in portion 3 holding the contacts 5 in parallel with one another by mold-in and a resin cover portion 4 formed as an element separate from the mold-in portion 3 and covering the mold-in portion 3. Each of the contacts 5 extends in a predetermined front-back direction (first direction) A1. A part formed by molding the contacts 5 in the mold-in portion 3 is herein called a molded component 10.

The electrical connector 1 further includes a metal shell 6 covering a periphery of the cover portion 4. The shell 6 has a rectangular tubular shape and is mounted outside the cover portion 4 and the mold-in portion 3 by press-fitting. Locking parts 61 formed on an upper plate portion and a lower plate portion of the shell 6 are engaged with locking holes 35 formed on an upper surface and a lower surface of the mold-in portion 3. Thus, the shell 6 is fixed to the cover portion 4.

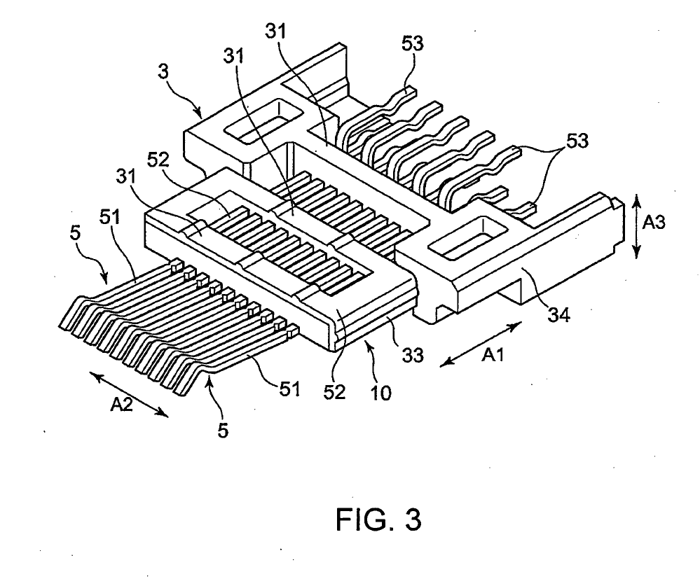

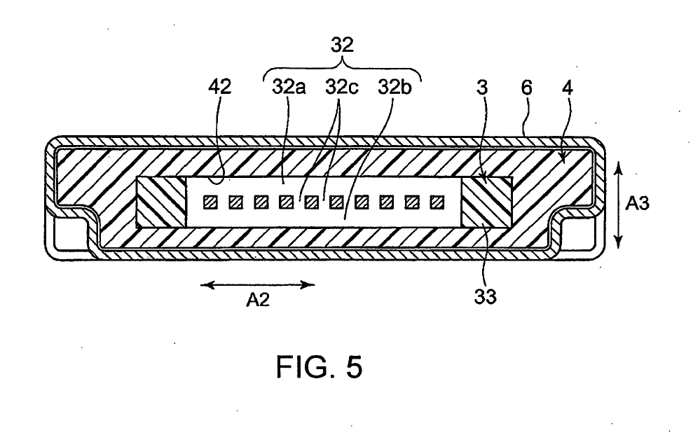

Referring to FIGS. 3 to 5, details of the electrical connector 1 will be described.

The mold-in portion 3 comprises a front half portion 33 having a relatively small dimension in a left-right direction (second direction) A2 perpendicular to the first direction A1 and a back half portion 34 having a relatively large dimension in the second direction A2. The cover portion 4 has a rectangular tubular shape as a whole and has a fitting opening 41 formed in its front section to receive a mating connector (not shown in the figure) and an insertion hole 42 formed in its rear section to receive and insert the front half portion 33 of the mold-in portion 3 therein. The front half portion 33 of the mold-in portion 3 is inserted into the insertion hole 42 of the cover portion 4 by press-fitting. The back half portion 34 of the mold-in portion 3 is formed so that its outer shape matches an outer shape of the cover portion 4 when the front half portion 33 is inserted into the insertion hole 42.

Each of the contacts 5 has an elongated shape comprising a contact spring portion (contacting portion) 51, a terminal portion 53, and a held portion 52 formed therebetween. The contact spring portions 51 protrude frontward of the mold-in portion 3 and are arranged in a line with a space from one another in the second direction A2. The terminal portions 53 protrude backward of the mold-in portion 3 and are arranged in two rows in a manner such that those terminal portions adjacent to one another in the second direction A2 are alternately separated in a vertical direction (third direction) A3 perpendicular to the first direction A1 and the second direction A2. The held portions 52 are molded-in with a resin to be held in the mold-in portion 3 in parallel with one another in the second direction A2. At least a part of each contact 5, which corresponds to the mold-in portion 3, extends in the first direction A1.

The mold-in portion 3 is formed into a thin shape with a reduced dimension in the third direction A3 and has three contact holding portions 31 intersecting the contacts 5 at three positions spaced from one another in the first direction A1. Each of the held portions 52 of the contacts 5 is held by the contact holding portions 31. Because of a structure in which the contacts 5 are molded in the mold-in portion 3, even if the held portion 52 of each contact 5 is reduced in size, a sufficient holding force is obtained. Further, a width of the held portion 52 of each contact 5, namely, the dimension in the third direction A3 can be reduced as compared to a conventional press-fit structure. Therefore, it is easy to achieve reduction in profile of the connector.

Between every adjacent ones of the contact holding portions 31, an air layer 32 is formed. In other words, the contact holding portions 31 form a plurality of, i.e., two air layers 32 inside the cover portion 4. The air layers 32 may communicate with each other and/or communicate with an atmosphere outside the electrical connector 1.

Each of the air layers 32 comprises a first layer, i.e., an upper layer 32a spreading on an upper side of the contacts 5, a second layer, i.e., a lower layer 32b spreading on a lower side of the contacts 5, and a plurality of pass-through portions 32c passing through between adjacent ones of the contacts 5 and connecting the upper layer 32a and the lower layer 32b. The held portion of each contact 5 has a part exposed to the air layers 32 and extending between the contact holding portions 31.

The electrical connector 1 is manufactured as follows.

First, the cover portion 4, the shell 6, and the molded component 10 formed by molding the contacts 5 in the mold-in portion 3 are prepared. Then, the shell 6 is press-fitted and mounted to an outside of the cover portion 4. Next, the mold-in portion 3 of the molded component 10 is inserted into the shell 6. Specifically, the front half portion 33 of the mold-in portion 3 is press-fitted into the insertion hole 42 of the cover portion 4 and the back half portion 34 is inserted into the shell 6. Thereafter, the locking parts 61 of the shell 6 are engaged with the locking holes 35 of the mold-in portion 3. Thus, the electrical connector 1 is completed.

As described above, the housing 2 has a two-element structure comprising the mold-in portion 3 and the cover portion 4, and the contacts 5 are held by the mold-in portion 3 by mold-in. Therefore, it is possible to obtain a necessary holding force without increasing the width of the held portion 52 of each contact 5. As a result, between adjacent ones of the contacts 5, opposing areas of the held portions 52 can be reduced. In addition, the air layers 32 passing through between the contacts 5 can easily be formed in the mold-in portion 3. Therefore, a capacitance between the contacts 5 is reduced so as to achieve reduction of crosstalk and impedance matching.

Thus, the housing 2 is provided with the mold-in portion 3 which holds the contacts 5 in parallel with one another by mold-in and the air layers 32 passing through between the contacts 5 are formed in the mold-in portion 3. Therefore, the electrical connector is advantageous in reduction of crosstalk and in impedance matching and is easily reduced in profile.

In the foregoing, the example in which the mold-in portion 3 has the three contact holding portions 31 has been described. However, the number of the contact holding portions 31 may be two, or four or more.

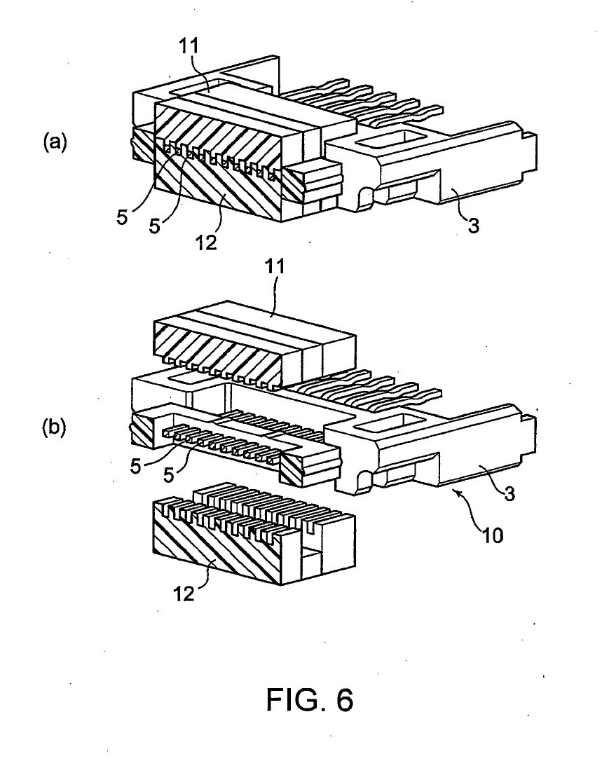

Referring to FIG. 6, a manufacturing method of the molded component 10 will be described.

For the purpose of achieving the miniaturization of the connector, the contacts 5 are designed to be extremely thin. Therefore, upon mold-in, it is required to partly support the contacts 5 in order to prevent deflection of the contacts.

The above-described molded component 10 has a structure in which the air layers 32 are provided at the center of the mold-in portion 3. Accordingly, it is easily possible to partly support the contacts 5 by using a section where the air layers 32 are to be formed. Specifically, the contacts 5 are sandwiched and supported between block-like upper and lower die parts 11 and 12 as shown in FIG. 6 (a). In this state, a mold-in operation is carried out. After the mold-in operation is finished, the upper and the lower die parts 11 and 12 are separated as shown in FIG. 6 (b).

As described above, since the air layers 32 are formed at the center of the mold-in portion 3, it is easily possible to prevent deflection of the contacts 5 upon mold-in.

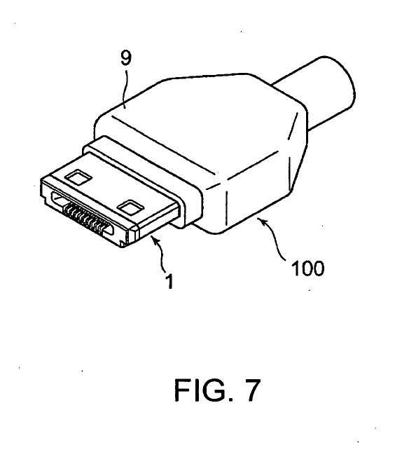

Referring to FIGS. 7 through 9, a relay connector manufactured using the electrical connector 1 will be described.

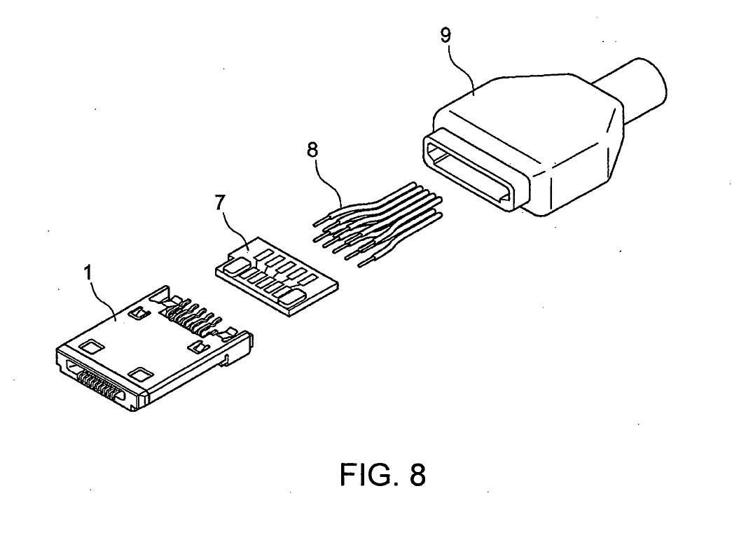

The relay connector 100 illustrated in FIGS. 7 and 8 is usable as an I/O connector for a mobile telephone and a mobile terminal and includes, in addition to the above-described electrical connector 1, a substrate 7 provided with a circuit pattern, a plurality of cables 8 only partly illustrated in the figure for convenience of illustration, and an insulating hood 9.

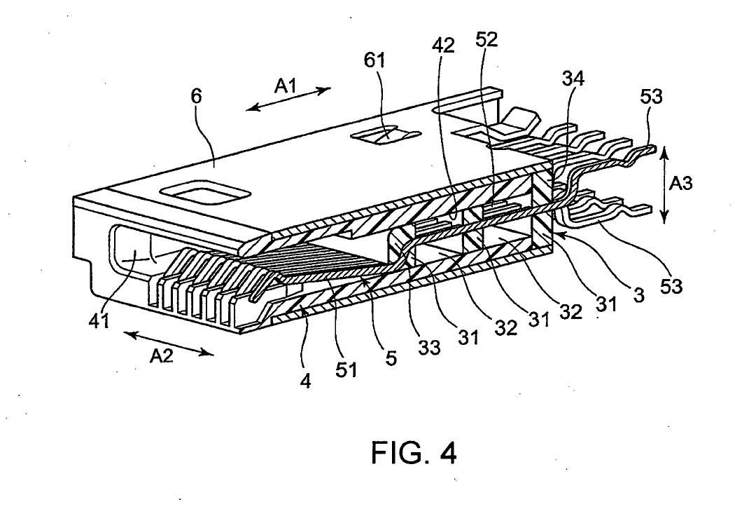

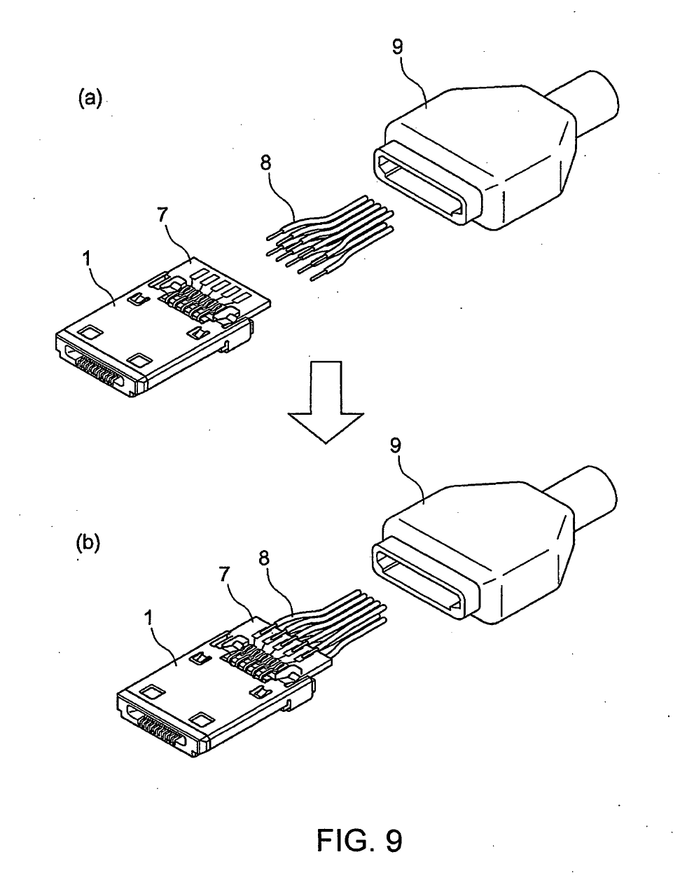

In order to manufacture the relay connector 100, at first, the substrate 7 is fixed to the electrical connector 1 as shown in FIG. 9 (a). Specifically, the substrate 7 is inserted between the terminal portions 53 separated above and below as shown in FIG. 4 and the circuit pattern of the substrate 7 is brought into contact with the terminal portions 53 to obtain electrical connection. Next, as shown in FIG. 9 (b), the cables 8 are connected to the circuit pattern of the substrate 7 by soldering or the like. Further, an assembly of the electrical connector 1, the substrate 7, and the cables 8 is overmolded with a resin to form the hood 9. Thus, the relay connector 100 shown in FIG. 7 is obtained.

The electrical connector 1 described using FIGS. 1 through 5 is applicable not only to the relay connector of the type shown in FIGS. 7 and 8 but also to other various types of connectors.

Hereinbelow, various embodiments of the present invention will be enumerated.

1. An electrical connector 1 comprising an insulating housing 2 and a plurality of conductive contacts 5 mounted to the housing 2, characterized in that each of the contacts 5 extends in a first direction A1, the housing 2 including a mold-in portion 3 holding the contacts 5 in parallel with one another by mold-in and a cover portion 4 formed as an element separate from the mold-in portion 3 and covering the mold-in portion 3, the mold-in portion 3 being provided with an air layer 32 which passes through between the contacts 5.

2. The electrical connector described in item 1, wherein the mold-in portion 3 has a plurality of contact holding portions 31 intersectingly holding the contacts 5 at a plurality of positions spaced from one another in the first direction A1, the air layer 32 being formed between the contact holding portions 31, the contacts 5 being exposed to the air layer 32.

3. The electrical connector described in item 1, wherein each of the contacts 5 comprises a contacting portion 51, a terminal portion 53, and a held portion 52 between the contacting portion 51 and the terminal portion 53, the held portion 52 being molded in the mold-in portion 3.

4. The electrical connector described in item 3, wherein the cover portion 4 has a fitting opening 41 for receiving a mating connector, the contacting portion 51 being positioned in the fitting opening 41.

5. The electrical connector described in item 1, further comprising a metal shell 6 covering a periphery of the cover portion 4.

6. The electrical connector described in item 1, wherein the mold-in portion 3 comprises a front half portion 33 having a relatively small dimension in a second direction A2 perpendicular to the first direction A1 and a back half portion 34 having a relatively large dimension in the second direction A2.

7. The electrical connector described in item 6, wherein the cover portion 4 has a rectangular tubular shape and has a fitting opening 41 formed at one end in the first direction A1 and adapted to receive a mating connector and an insertion hole 42 formed at an opposite end in the first direction A1 and adapted to receive and insert the front half portion 33 therein.

8. The electrical connector described in item 7, wherein the front half portion 33 is inserted into the insertion hole 42 by press-fitting and the back half portion 34 has an outer shape which matches an outer shape of the cover portion 4 when the front half portion 33 is inserted into the insertion hole 42.

9. The electrical connector described in item 1, wherein each of the contacts 5 comprises a contact spring portion 51, a terminal portion 53, and a held portion 52 between the contact spring portion 51 and the terminal portion 53, the contact spring portion 51 protruding from the mold-in portion 3 at one side in the first direction A1, the terminal portion 52 protruding from the mold-in portion 3 at an opposite side in the first direction A1.

10. The electrical connector described in item 9, wherein the contacts 5 are arranged in parallel in a second direction A2 perpendicular to the first direction A1, the terminal portions 53 being arranged in two rows in a manner such that adjacent ones thereof in the second direction A2 are alternately separated in a third direction A3 perpendicular to the first direction A1 and the second direction A2.

11. The electrical connector described in item 1, wherein the air layer 32 includes a first layer 32a spreading on one side of an array of the contacts 5, a second layer 32b spreading on an opposite side of the array of the contacts 5, and a plurality of pass-through portions 32c passing through between adjacent ones of the contacts 5 and connecting the first layer 32a and the second layer 32b.

In the foregoing, the present invention has been described using the embodiments. However, the present invention is not limited to the above-described embodiments. Within the scope of the present invention, the structure and the details of the present invention may be modified in various manners which are comprehensible by persons skilled in the art.

This application is based upon and claims the benefit of priority from Japanese Patent Application No. 2009-55240 filed on Mar. 9, 2009, the disclosure of which is incorporated herein in its entirety by reference.

### INDUSTRIAL APPLICABILITY

The present invention is applicable to a relay connector, such as an I/O connector used in a mobile telephone and a mobile terminal dealing with high speed data communication.

Description of Reference Numerals:

1 electrical connector

2 housing

3 mold-in portion

31 contact holding portion

32 air layer

32a upper layer

32b lower layer

32c pass-through portion

33 front half portion

34 back half portion

35 locking hole

4 cover portion

41 fitting opening

42 insertion hole

5 contact

51 contact spring portion

52 held portion

53 terminal portion

6 metal shell

61 locking part

7 substrate

8 cable

9 hood

10 molded component

11, 12 die part

100 relay connector

1. An electrical connector comprising an insulating housing and a plurality of conductive contacts mounted to the housing, wherein each of the contacts extends in a first direction, the housing including a mold-in portion holding the contacts in parallel with one another by mold-in and a cover portion formed as an element separate from the mold-in portion and covering the mold-in portion, the mold-in portion being provided with an air layer which passes through between the contacts.

2. The electrical connector as claimed in claim 1, wherein the mold-in portion has a plurality of contact holding portions intersectingly holding the contacts at a plurality of positions spaced from one another in the first direction, the air layer being formed between the contact holding portions, the contacts being exposed to the air layer.

3. The electrical connector as claimed in claim 1, wherein each of the contacts comprises a contacting portion, a terminal portion, and a held portion between the contacting portion and the terminal portion, the held portion being molded in the mold-in portion.

4. The electrical connector as claimed in claim 3, wherein the cover portion has a fitting opening for receiving a mating connector, the contacting portion being positioned in the fitting opening.

5. The electrical connector as claimed in claim 1, further comprising a metal shell covering a periphery of the cover portion.

6. The electrical connector as claimed in claim 1, wherein the mold-in portion comprises a front half portion having a relatively small dimension in a second direction perpendicular to the first direction and a back half portion having a relatively large dimension in the second direction.

7. The electrical connector as claimed in claim 6, wherein the cover portion has a rectangular tubular shape and has a fitting opening formed at one end in the first direction and adapted to receive a mating connector and an insertion hole formed at an opposite end in the first direction and adapted to receive and insert the front half portion therein.

8. The electrical connector as claimed in claim 7, wherein the front half portion is inserted into the insertion hole by press-fitting and the back half portion has an outer shape which matches an outer shape of the cover portion when the front half portion is inserted into the insertion hole.

9. The electrical connector as claimed in claim 1, wherein each of the contacts comprises a contact spring portion, a terminal portion, and a held portion between the contact spring portion and the terminal portion, the contact spring portion protruding from the mold-in portion at one side in the first direction, the terminal portion protruding from the mold-in portion at an opposite side in the first direction.

10. The electrical connector as claimed in claim 9, wherein the contacts are arranged in parallel in a second direction perpendicular to the first direction, the terminal portions being arranged in two rows in a manner such that adjacent ones thereof in the second direction are alternately separated in a third direction perpendicular to the first direction and the second direction.

11. The electrical connector as claimed in claim 1, wherein the air layer includes a first layer spreading on one side of an array of the contacts, a second layer spreading on an opposite side of the array of the contacts, and a plurality of pass-through portions passing through between adjacent ones of the contacts and connecting the first layer and the second layer.
